(19) United States
(12) Patent Application Publication
(10) Pub. No.: US 2026/0074284 A1
(43) Pub. Date: Mar. 12, 2026

(54) NON-AQUEOUS ELECTROLYTE SOLUTION FOR LITHIUM ION SECONDARY BATTERY AND LITHIUM ION SECONDARY BATTERY

(71) Applicant: Prime Planet Energy & Solutions, Inc., Tokyo (JP)

(72) Inventor: Ryoka HOSOI, Nagoya-shi (JP)

(21) Appl. No.: 19/299,339

(22) Filed: Aug. 14, 2025

(30) Foreign Application Priority Data
Sep. 9, 2024 (JP) 2024-154940

(51) Int. Cl. H01M 10/0567; H01M 10/0525; H01M 10/0569

(52) U.S. Cl. CPC H01M 10/0567; H01M 10/0525; H01M 10/0569; H01M 2300/0025

(57) ABSTRACT

The non-aqueous electrolyte solution disclosed herein includes a supporting salt, a non-aqueous solvent and a compound having a triphenylmethane skeleton. The above-described compound includes a branched hydrocarbon group and a hydroxy group. The above-described branched hydrocarbon group exists on a phenyl group in the above-described triphenylmethane skeleton and has 3 or more carbon atoms. The above-described hydroxy group exists on the above-described phenyl group and is next to the above-described branched hydrocarbon group.

### CROSS REFERENCE TO RELATED APPLICATION

This application claims the benefit of priority to Japanese Patent Application No. 2024-154940 filed on Sep. 9, 2024. The entire contents of this application are hereby incorporated herein by reference.

### BACKGROUND OF THE DISCLOSURE

### 1. Field

The present disclosure relates to a lithium ion secondary battery, and particularly to a non-aqueous electrolyte solution used in a lithium ion secondary battery, and a lithium ion secondary battery using the non-aqueous electrolyte solution.

### 2. Background

Japanese Patent Application Laid-Open No. 2022-87412 discloses a non-aqueous electrolyte solution for a lithium ion secondary battery, containing a lithium salt as an electrolyte salt, a non-aqueous solvent, and an aromatic carboxylic acid compound and an aryl halide compound as additives. It also discloses a lithium ion secondary battery including the non-aqueous electrolyte solution.

### SUMMARY

Incidentally, it has been demanded to further develop a technique that can suppress the growth of deposited metallic lithium in lithium ion secondary batteries.

The non-aqueous electrolyte solution disclosed herein includes a supporting salt, a non-aqueous solvent, and a compound having a triphenylmethane skeleton. The above-described compound includes a branched hydrocarbon group and a hydroxy group. The above-described branched hydrocarbon group exists on a phenyl group in the above-described triphenylmethane skeleton and has 3 or more carbon atoms. The above-described hydroxy group exists on the above-described phenyl group and is next to the above-described branched hydrocarbon group. According to the non-aqueous electrolyte solution having such structure, the growth of deposited metallic lithium can be suppressed.

The lithium ion secondary battery disclosed herein includes a positive electrode, a negative electrode and any of non-aqueous electrolyte solutions disclosed herein. According to such structure, there is provided a lithium ion secondary battery in which the growth of deposited metallic lithium can be suppressed.

### BRIEF DESCRIPTION OF THE DRAWINGS

FIG. 1A is a first explanatory diagram illustrating the trapping of metallic lithium according to one embodiment;

FIG. 1B is a second explanatory diagram illustrating the trapping of metallic lithium according to one embodiment;

FIG. 1C is a third explanatory diagram illustrating the trapping of metallic lithium according to one embodiment;

FIG. 2 is a cross-sectional view schematically showing a lithium ion secondary battery according to one embodiment; and

FIG. 3 is a perspective view schematically showing an electrode body in a lithium ion secondary battery according to one embodiment.

### DETAILED DESCRIPTION OF THE EMBODIMENTS

Some embodiments of techniques disclosed herein will now be described with reference to the drawings. The same signs are assigned to members and parts having the same actions in the following drawings for illustration. Also, dimensional relationships (length, width, thickness, etc.) in each diagram do not reflect actual dimensional relationships. It should be noted that things which are other than the matters particularly mentioned in the present specification, and are necessary for implementation of the techniques disclosed herein (for example, general structures and manufacturing processes for the non-aqueous electrolyte solution for a lithium ion secondary battery and the lithium ion secondary battery which do not characterize the present disclosure) can be understood as design matters of those skilled in the art based on conventional techniques in the art. The techniques disclosed herein can be performed based on the contents disclosed in the present specification and the common general technical knowledge in the art. In addition, the following description is not intended to limit the present disclosure to the following embodiments.

The notation of “A to B” showing a range means “A or more and B or less” in the present specification. It also encompasses “more than A” and “less than B.” In addition, the signs X and Y in the drawings represent the short side direction of a lithium ion secondary battery 100 and the long side direction perpendicular to the short side direction, respectively, in the following description. However, these are merely directions for the convenience of the description and do not limit the installation mode of the lithium ion secondary battery 100 in any way.

It should be noted that the “lithium ion secondary battery” indicates a secondary battery which is charged and discharged by transferring Li ion, a charge carrier, between a positive electrode and a negative electrode in the present specification. A secondary battery generally called e.g. lithium secondary battery (or lithium ion battery) is a typical example encompassed in the lithium ion secondary battery in the present specification. In addition, the “active material” in the present specification indicates a material (compound) relating to Li ion occlusion and release on the positive electrode side and the negative electrode side.

### <Non-Aqueous Electrolyte Solution for Lithium Ion Secondary Battery>

First, one embodiment of the non-aqueous electrolyte solution for a lithium ion secondary battery disclosed herein will be described. The non-aqueous electrolyte solution for a lithium ion secondary battery according to the present embodiment includes a supporting salt, a non-aqueous solvent and a compound having a triphenylmethane skeleton. The above-described compound includes a branched hydrocarbon group and a hydroxy group. The above-described branched hydrocarbon group exists on a phenyl group in the triphenylmethane skeleton and has 3 or more carbon atoms. In addition, the above-described hydroxy group exists on the above-described phenyl group and is next to the above-described branched hydrocarbon group. The details will be described below; however, the above-described compound functions as a Li collector to trap deposited metallic lithium. Therefore, further growth of deposited metallic lithium can be suppressed by the non-aqueous electrolyte solution including a Li collector. Each constituent will now be described. It should be noted that the above-described compound is referred to as “Li collector” in the following description.

A known lithium salt which has been used as an electrolyte salt in a non-aqueous electrolyte solution for a lithium ion secondary battery may be used as the supporting salt. Examples of the lithium salt which can be used include LiPF₆, LiBF₄, lithium bis(fluorosulfonyl)imide (LiFSI), lithium bis(trifluoromethane) sulfone imide (LiTFSI) and the like. These can be used individually or two or more of them can be used in combination. The lithium salt is preferably LiPF₆. The concentration of the lithium salt in the non-aqueous electrolyte solution is not particularly limited, and is for example 0.5 mol/L to 1.5 mol/L and preferably 0.7 mol/L to 1.2 mol/L.

The non-aqueous solvent is not particularly limited, and a known non-aqueous solvent which has been used in a non-aqueous electrolyte solution for a lithium ion secondary battery may be used. Examples of the non-aqueous solvent include carbonates, ethers, esters, nitriles, sulfones, lactones and the like. It is preferred that the non-aqueous solvent include a non-aqueous solvent belonging to ethers or carbonates because the effect of suppressing the growth of deposited metallic lithium is particularly high. In addition, from the viewpoint of being able to easily dissolve a Li collector, it is particularly preferred that the non-aqueous solvent include a non-aqueous solvent belonging to carbonates.

Examples of ethers include chain ethers such as dimethoxyethane, diethyl ether, 1,3-dioxolane, glyme, diglyme, triglyme and tetraglyme; cyclic ethers such as dioxane, tetrahydrofuran and 2-methyltetrahydrofuran and the like. These can be used individually or two or more of them can be used in combination.

Examples of carbonates include ethylene carbonate (EC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), trifluoro dimethyl carbonate (TFDMC) and the like. These can be used individually or two or more of them can be used in combination. As carbonates, ethylene carbonate, dimethyl carbonate and ethyl methyl carbonate are particularly preferably used. The carbonates preferably contain at least one of three carbonates listed above. In addition, the carbonates are more preferably a mixed solvent containing at least two of three carbonates listed above.

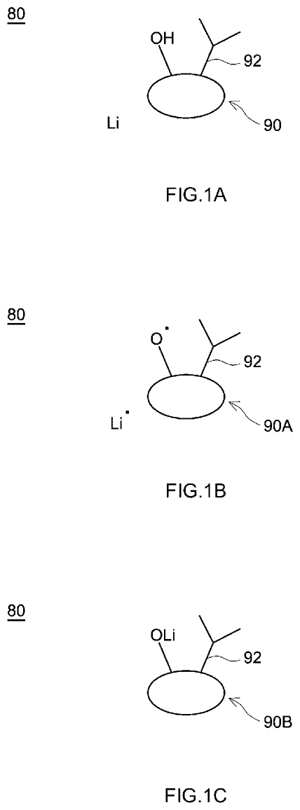

A mechanism in which the growth of metallic lithium deposited on an electrode in a lithium ion secondary battery is suppressed by a Li collector can be thought as follows; however, it is not intended to be interpreted in a limited way. Herein, FIG. 1A is a first explanatory diagram illustrating the trapping of metallic lithium according to one embodiment. FIG. 1B is a second explanatory diagram illustrating the trapping of metallic lithium according to one embodiment. FIG. 1C is a third explanatory diagram illustrating the trapping of metallic lithium according to one embodiment. It should be noted that a Li collector 90 having an isopropyl group as a branched hydrocarbon group 92 is shown in FIGS. 1A to 1C; however, as is obvious, it is not intended to limit the Li collector disclosed herein to such structure.

As shown in FIG. 1A, first, a non-aqueous electrolyte solution 80 for a lithium ion secondary battery according to the present embodiment contains the Li collector 90 having a triphenylmethane skeleton. It also has the branched hydrocarbon group 92 and a hydroxy group next to the branched hydrocarbon group 92 on at least one phenyl group in the triphenylmethane skeleton. Subsequently, as shown in FIG. 1B, the oxygen atom of the hydroxy group in the Li collector 90 is radicalized in the non-aqueous electrolyte solution 80. The Li collector 90 is changed to a radical body 90A in the non-aqueous electrolyte solution 80. The radicalized oxygen atom (hereinafter also referred to as “oxygen radical”) reacts with, for example, metallic lithium deposited on a surface of a negative electrode 60 to trap lithium element (lithium radical). Then, as shown in FIG. 1C, in the non-aqueous electrolyte solution 80, the radical body 90A is changed to a poorly soluble lithium adduct 90B, which is deposited.

Herein, it is known that compounds having a radical are generally unstable and have very high reactivity. Meanwhile, the radical body 90A has the branched hydrocarbon group 92 which is close to the oxygen radical and is bulky (large steric hindrance). Because of this, the reactivity of the oxygen radical is suitably reduced and stabilized. That is to say, because the oxygen radical and the branched hydrocarbon group 92 are next to each other, the oxygen atom can maintain the state of the oxygen radical. Then, metallic lithium and the oxygen radical react to generate the lithium adduct 90B. The lithium adduct 90B can exist inside a lithium ion secondary battery 100 without returning to metallic lithium again. Herein, unlike metallic lithium, the lithium adduct 90B does not grow into a dendritic form. That is to say, metallic lithium is changed to the lithium adduct 90B and the growth thereof is suppressed. This can suitably prevent metallic lithium deposited on the negative electrode 60 from growing and passing (penetrating) through a separator sheet 70 to touch a positive electrode 50, causing internal short circuit. By doing this, the battery performance of the lithium ion secondary battery 100 can be suitably improved.

Specific examples of the Li collector having the above-described effect will now be described. It should be noted that the following specific examples are not intended to limit the present disclosure to these specific examples. As described above, the Li collector has the triphenylmethane skeleton. The Li collector includes a branched hydrocarbon group and a hydroxy group. The above-described branched hydrocarbon group exists on a phenyl group in the triphenylmethane skeleton and has 3 or more carbon atoms. In addition, the above-described hydroxy group exists on the above-described phenyl group and is next to the branched hydrocarbon group. In the Li collector, the carbon atom to which the hydroxy group is bound exists next to the carbon atom to which the branched hydrocarbon group is bound on the phenyl group. Herein, the above-described branched hydrocarbon group and the above-described hydroxy group may exist on only one phenyl group, two phenyl groups or 3 phenyl groups among the phenyl groups in the triphenylmethane skeleton. In addition, only one pair or two or more pairs (a plurality of pairs) of the above-described branched hydrocarbon group and the above-described hydroxy group may exist on one phenyl group. It should be noted that the “triphenylmethane skeleton” in the present disclosure encompasses a skeleton represented by the following chemical formula (1) and a skeleton represented by the following chemical formula (2).

### [Chem. 1]

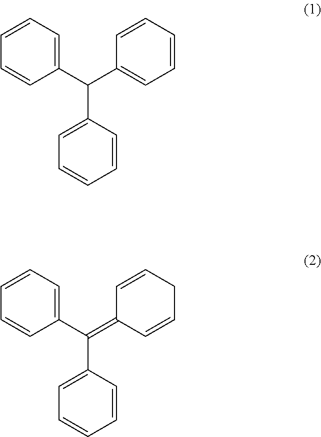

### [Chem. 2]

Examples of the Li collector include those represented by the following general formula (3). Herein, each R in the following general formula (3) is individually any of a hydrogen atom, a chain hydrocarbon group (chain alkyl group), a branched hydrocarbon group (branched alkyl group) having 3 or more carbon atoms, a phenyl group, a benzyl group, a halogen atom, a hydroxy group, a CH₂N(CH₂COOH)₂ group, a sulfone group and a carboxy group. In addition, a branched hydrocarbon group and a hydroxy group next to the branched hydrocarbon group are included on at least one phenyl group in the following general formula (3).

### [Chem. 3]

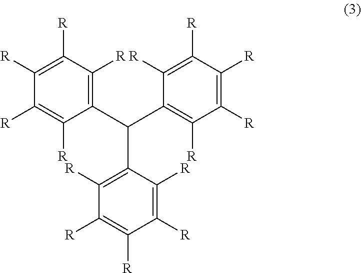

Herein, with respect to R in the above-described chemical formula (3), the number of carbon atoms in the chain hydrocarbon group is for example 1 to 6, preferably 1 to 4 and more preferably 1 to 3. Examples of the chain hydrocarbon group include a methyl group, an ethyl group, an n-propyl group, an n-butyl group, an n-pentyl group, an n-hexyl group and the like. The number of carbon atoms in the branched hydrocarbon group is 3 or more as described above. The number of carbon atoms in the branched hydrocarbon group is for example 3 to 15, preferably 3 to 10 and more preferably 3 to 6. Suitable examples of the branched hydrocarbon group include an isopropyl group, an isobutyl group, a sec-butyl group, a tert-butyl group, an isopentyl group, a neopentyl group, a tert-pentyl group, a cyclopentyl group, a 2-ethylbutyl group, a cyclohexyl group and the like. Among these, any of an isopropyl group, an isobutyl group, a sec-butyl group and a tert-butyl group is particularly preferably used. Examples of the halogen atom include a fluorine atom, a chlorine atom, a bromine atom, an iodine atom and the like. Among these, any of a chlorine atom, a fluorine atom and a bromine atom is preferably used.

Other examples of the Li collector include those represented by the following general formula (4). Herein, each R in the following general formula (4) is individually any of a hydrogen atom, a chain hydrocarbon group (chain alkyl group), a branched hydrocarbon group (branched alkyl group) having 3 or more carbon atoms, a phenyl group, a benzyl group, a halogen atom, a hydroxy group, a CH₂N(CH₂COOH)₂ group, a sulfone group and a carboxy group. R^{a} in the following general formula (4) is any of an oxygen atom, an amino group, an NHX group and an NX¹X² group. X, X¹ and X² are a hydrocarbon group (alkyl group) or a phenyl group which may have a substituent group. It should be noted that X¹ and X² may be the same substituent group or different substituent groups. When R^{a} is any of an amino group, an NHX group and an NX¹X² group, X, X¹ and X² exist in an ammonium cation form. In addition, a branched hydrocarbon group and a hydroxy group next to the branched hydrocarbon group are included on at least one phenyl group in the following general formula (4).

### [Chem. 4]

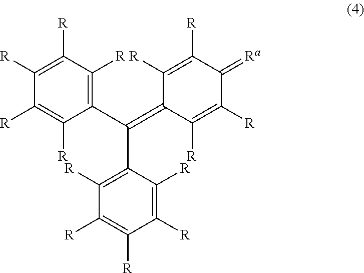

Herein, with respect to Rs in the above chemical formula (4), the number of carbon atoms in the acyclic hydrocarbon group is for example 1 to 6, preferably 1 to 4 and more preferably 1 to 3. Examples of the chain hydrocarbon group include a methyl group, an ethyl group, an n-propyl group, an n-butyl group, an n-pentyl group, an n-hexyl group and the like. The number of carbon atoms in the branched hydrocarbon group is 3 or more as described above. The number of carbon atoms in the branched hydrocarbon group is for example 3 to 15, preferably 3 to 10 and more preferably 3 to 6. Suitable examples of the branched hydrocarbon group include an isopropyl group, an isobutyl group, a sec-butyl group, a tert-butyl group, an isopentyl group, a neopentyl group, a tert-pentyl group, a cyclopentyl group, a 2-ethylbutyl group, a cyclohexyl group and the like. Among these, any of an isopropyl group, an isobutyl group, a sec-butyl group and a tert-butyl group is particularly preferably used. The halogen atom includes a fluorine atom, a chlorine atom, a bromine atom, an iodine atom and the like. Among these, any of a chlorine atom, a fluorine atom and a bromine atom is preferably used.

With respect to X, X¹ and X² of R^{a} in the above chemical formula (4), the hydrocarbon group may be linear or branched. The number of carbon atoms in the hydrocarbon group is for example 1 to 6, preferably 1 to 4 and more preferably 1 to 3. Examples of the hydrocarbon group include a methyl group, an ethyl group, an n-propyl group, an n-butyl group, an n-pentyl group, an n-hexyl group, a phenyl group, a benzyl group and the like. In addition, the phenyl group may or may not have a substituent group. When the phenyl group has a substituent group, examples of the substituent group include a hydrocarbon group having 1 to 6 carbon atoms, a hydroxy group, a halogen atom and the like.

It should be noted that the sulfone group (—SO₃H) and the carboxy group (—COOH) may exist in a state in which the hydrogen atom in the hydroxy group is substituted with a salt in the above chemical formulae (3) and (4). The types of such salts include an alkaline metal salt, an alkaline earth metal salt, an ammonium salt and the like. Examples of the alkaline metal salt include a lithium salt, a sodium salt, a potassium salt and the like. Examples of the alkaline earth metal salt include a magnesium salt, a calcium salt and the like.

The Li collectors can be used individually or two or more of them can be used in combination. Suitable examples of the Li collector include thymol blue, bromothymol blue, methylthymol blue and the like. Herein, the following chemical formulae (5) to (7) represent thymol blue, bromothymol blue and methylthymol blue respectively.

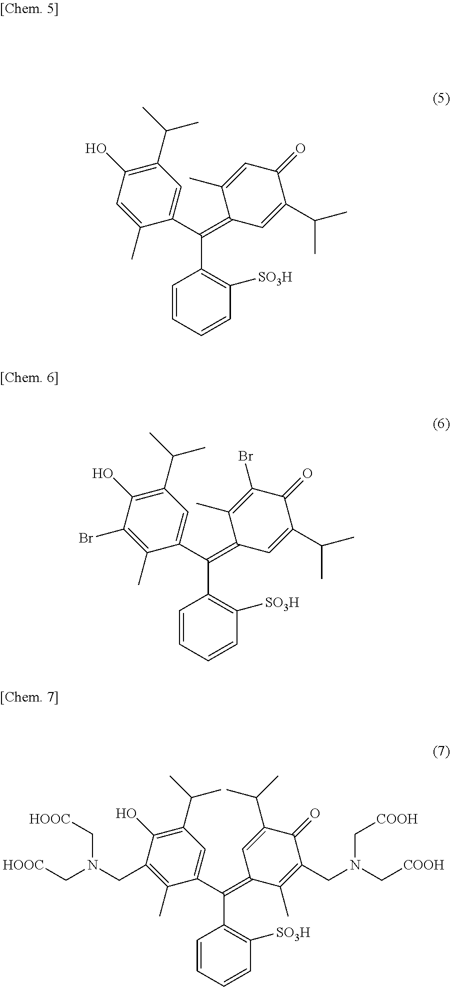 [SMILES: CC1=CC(=O)C(C(C)C)=C/C1=C(/c1cc(C(C)C)c(O)cc1C)c1ccccc1S(=O)(=O)O ; CC1=C(Br)C(=O)C(C(C)C)=C/C1=C(\c1ccccc1S(=O)(=O)O)c1cc(C(C)C)c(O)c(Br)c1C ; CC1=C(CN(CC(=O)O)CC(=O)O)C(=O)C(C(C)C)=C/C1=C(/c1ccccc1S(=O)(=O)O)c1cc(C(C)C)c(O)c(CN(CC(=O)O)CC(=O)O)c1C]

The concentration of the Li collector in the non-aqueous electrolyte solution is not particularly restricted as long as the effects of the techniques disclosed herein are displayed. As the concentration increases, the effect of suppressing the growth of deposited metallic lithium is higher until the concentration of the Li collector reaches a constant value. However, when the concentration of the Li collector is beyond the constant value, the effect of suppressing the growth of deposited metallic lithium is saturated. Because of this, the concentration of the Li collector in the non-aqueous electrolyte solution is for example 0.05 mmol/L or more, preferably 0.1 mmol/L or more and more preferably 0.2 mmol/L or more. In addition, the upper limit of the concentration of the Li collector in the non-aqueous electrolyte solution is for example 2 mmol/L or less, preferably 1.5 mmol/L or less (for example 1.2 mmol/L or less) and more preferably 1.1 mmol/L or less. It should be noted that when two or more Li collectors are used in combination, the total concentration thereof can be considered as the concentration of the Li collector.

The non-aqueous electrolyte solution for a lithium ion secondary battery according to the present embodiment may include various additives, for example a gas generating agent such as biphenyl (BP) or cyclohexylbenzene (CHB); a film forming agent; a dispersing agent; and a thickening agent as long as the effects of the present disclosure are not remarkably damaged. The concentration of additives in the non-aqueous electrolyte solution is not particularly limited, and is for example 0.01 mmol/L to 1 mmol/L and preferably 0.05 mmol/L to 0.5 mmol/L.

The non-aqueous electrolyte solution 80 for a lithium ion secondary battery according to the present embodiment can be used for the lithium ion secondary battery 100 in accordance with known methods. In the lithium ion secondary battery 100, the growth of deposited metallic lithium can be suppressed by using the non-aqueous electrolyte solution 80 for a lithium ion secondary battery according to the present embodiment for the lithium ion secondary battery 100.

### <Lithium Ion Secondary Battery>

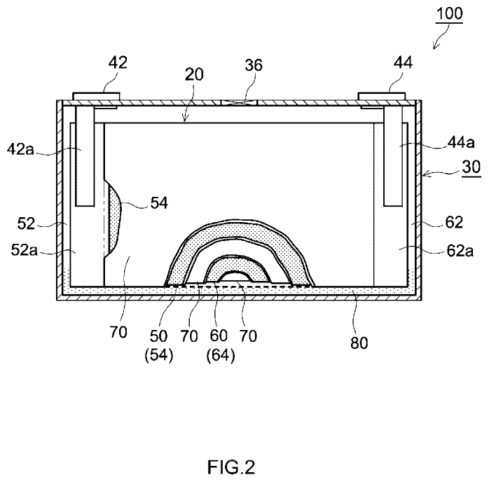

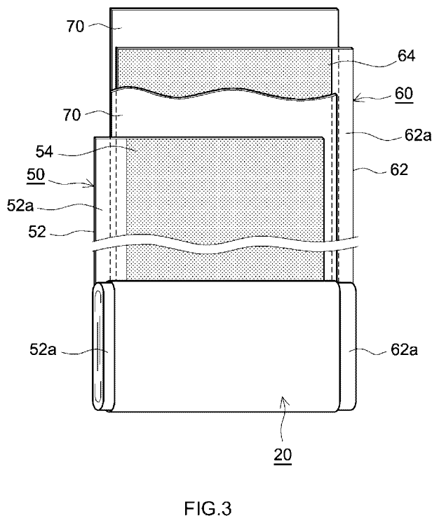

Subsequently, the lithium ion secondary battery according to the present embodiment will be described. Herein, FIG. 2 is a cross-sectional view schematically showing a lithium ion secondary battery according to one embodiment. FIG. 3 is a perspective view schematically showing an electrode body in a lithium ion secondary battery according to one embodiment. As shown in FIG. 2, the lithium ion secondary battery 100 according to the present embodiment includes a positive electrode 50, a negative electrode 60 and a non-aqueous electrolyte solution 80. According to such structure, it is possible to provide the lithium ion secondary battery 100 in which the growth of deposited metallic lithium can be suppressed. Each constituent will now be described.

The lithium ion secondary battery 100 shown in FIG. 2 is a sealed battery assembled by putting a flat-shaped wound electrode body 20 and the non-aqueous electrolyte solution 80 in a flat square battery case (i.e. outer container) 30. The battery case 30 has a positive electrode terminal 42 and a negative electrode terminal 44 for external connection, and a thin safety valve 36 set to release the inner pressure of the battery case 30 when the inner pressure is increased to a predetermined level or more. In addition, the battery case 30 has an inlet (not shown) to inject the non-aqueous electrolyte solution 80. The positive electrode terminal 42 is electrically connected to a positive electrode current collector plate 42a. The negative electrode terminal 44 is electrically connected to a negative electrode current collector plate 44a. As the material of the battery case 30, for example, a metal material which is lightweight and has good heat conductivity such as aluminum is used.

As shown in FIG. 2 and FIG. 3, the wound electrode body 20 has a form in which a positive electrode sheet 50 and a negative electrode sheet 60 are stacked with two long separator sheets 70 interposed therebetween and wound in the longitudinal direction. The positive electrode sheet 50 has a structure in which a positive electrode active material layer 54 is formed on one side or both sides (both sides herein) of a long positive electrode current collector 52 along the longitudinal direction. The negative electrode sheet 60 has a structure in which a negative electrode active material layer 64 is formed on one side or both sides (both sides herein) of a long negative electrode current collector 62 along the longitudinal direction. A portion in which the positive electrode active material layer was not formed 52a (that is, a portion in which the positive electrode active material layer 54 is not formed and the positive electrode current collector 52 is exposed) and a portion in which the negative electrode active material layer was not formed 62a (that is, a portion in which the negative electrode active material layer 64 is not formed and the negative electrode current collector 62 is exposed) are formed to protrude outward from both ends in the winding axial direction of the wound electrode body 20 (that is, a sheet width direction perpendicular to the above-described longitudinal direction). The positive electrode current collector plate 42a and the negative electrode current collector plate 44a are joined to the portion in which the positive electrode active material layer was not formed 52a and the portion in which the negative electrode active material layer was not formed 62a, respectively.

For the positive electrode sheet 50 and the negative electrode sheet 60, the same as used for conventional lithium ion secondary batteries can be used without particular restrictions. A typical aspect will now be described.

Examples of the positive electrode current collector 52 constituting the positive electrode sheet 50 include aluminum foil and the like. The positive electrode active material layer 54 contains at least a positive electrode active material. Examples of the positive electrode active material include lithium transition metal oxides (e.g. LiNi_{1/3}Co_{1/3}Mn_{1/3}O₂, LiNiO₂, LiCoO₂, LiFeO₂, LiMn₂O₄, LiNi_{0.8}Co_{0.15}Al_{0.5}O₂, LiNi_{0.8}Mn_{1.5}O₄, etc.), lithium transition metal phosphate compounds (e.g. LiFePO₄, etc.) and the like. The positive electrode active material layer 54 can contain components other than the active material such as a conducting material and a binder. As the conducting material, for example, carbon black such as acetylene black (AB) and other (e.g. graphite, etc.) carbon materials can be suitably used. As the binder, for example, polyvinylidene difluoride (PVDF) and the like can be used.

Examples of the negative electrode current collector 62 constituting the negative electrode sheet 60 include copper foil and the like. The negative electrode active material layer 64 contains at least a negative electrode active material. As the negative electrode active material, for example, a carbon material such as graphite, hard carbon or soft carbon can be used, and black lead is preferably used. The negative electrode active material layer 64 can contain a component other than the active material such as a binder or a thickening agent. As the binder, for example, styrene butadiene rubber (SBR) and the like can be used. As the thickening agent, for example, carboxymethyl cellulose (CMC) and the like can be used.

Examples of the separator sheet 70 include porous sheets (films) having resins such as polyethylene (PE), polypropylene (PP), polyester, cellulose and polyamide. Such porous sheet may have a single layer structure or a laminated structure having two or more layers (for example, a three layer structure having PP layers laminated on both sides of a PE layer). A heat resistance layer (HRL) may be provided on a surface of the separator sheet 70.

The non-aqueous electrolyte solution for a lithium ion secondary battery according to the present embodiment described above is used for the non-aqueous electrolyte solution 80. It should be noted that FIG. 2 does not strictly show the amount of the non-aqueous electrolyte solution 80 injected into the battery case 30.

The lithium ion secondary battery 100 can be used for various applications. Suitable applications include driving power supply mounted in vehicles such as battery electric vehicles (BEV), hybrid electric vehicles (HEV) and plug-in hybrid electric vehicles (PHEV). In addition, the lithium ion secondary battery 100 can be used as a storage battery for e.g. a small electricity storage device. Typically, the lithium ion secondary battery 100 can be also used in the form of an assembled battery in which a plurality of batteries are connected in series and/or in parallel.

It should be noted that the rectangular lithium ion secondary battery 100 having the flat-shaped wound electrode body 20 was described as an example. However, the lithium ion secondary battery can be also constituted as a lithium ion secondary battery having a laminated electrode body (that is, an electrode body in which a plurality of positive electrodes and a plurality of negative electrodes are laminated alternately). In addition, the lithium ion secondary battery can be also constituted as a cylindrical lithium ion secondary battery, a laminate lithium ion secondary battery or the like.

### Test Examples

Test examples relating to the techniques disclosed herein will now be described. It should be noted that Test Examples described below are not intended to limit the techniques disclosed herein.

### A. First Test

In this test, thymol blue (CAS: 76-61-9) represented by the above chemical formula (5) was prepared as a Li collector. Then, the solubility and Li trapping performance of this Li collector were examined. Specific experimental contents are as follows.

First, 1000 mL of a non-aqueous solvent (EMC:ethyl methyl carbonate) was put in an Eppendorf tube. Then, 100 mg of thymol blue and 0.5 g of Li foil were added thereto, and the obtained mixture was then shaken with a stirrer (shaking time: 3 minutes, shaking speed: 700 rpm). The amount of dissolved thymol blue at this time was 0.1 mg/mL (0.2 mmol/L). Consequently, a compound having red color was generated, and Li foil remaining in the non-aqueous solvent was reduced to about 0.4 g. This found that the Li collector (thymol blue herein) reduced metallic lithium in the non-aqueous solvent by the trapping of Li foil (metallic Li).

### B. Second Test

In this test, the effect of the Li collector in an actual lithium ion secondary battery was investigated. Lithium ion secondary batteries (Test Examples) prepared in this test will now be described.

### 1. Each Test Example

### (1) Test Example 1

In Test Example 1, a lithium ion secondary battery was produced without adding a Li collector. Specifically, first, a positive electrode active material (LiNi_{1/3}Co_{1/3}Mn_{1/3}O₂), a conducting material (acetylene black) and a binder (PVdF) were mixed in a proportion of 90:8:2, and the obtained mixture was dispersed in a dispersion medium (NMP:N-methylpyrrolidone) to prepare a positive electrode mixture paste. Then, this positive electrode mixture paste was applied to both sides of a positive electrode current collector (aluminum foil), and drying and rolling were subsequently performed to produce a sheet-shaped positive electrode. It should be noted that the size of the positive electrode was 47 mm×45 mm. Then, an aluminum positive electrode terminal was connected to this positive electrode.

Subsequently, in this Test Example, a negative electrode active material (graphite) and a binder (SBR) were mixed in a proportion of 98:2, and the obtained mixture was dispersed in a dispersion medium (NMP) to prepare a negative electrode mixture paste. Then, this paste was applied to both sides of a negative electrode core (copper foil), and drying and rolling were subsequently performed to produce a sheet-shaped negative electrode. It should be noted that the size of the negative electrode was 49 mm×47 mm. Then, a copper negative electrode terminal was connected to this negative electrode.

Next, a laminated body was produced in which a polypropylene microporous separator (size: 51 mm×49 mm) was arranged between the positive electrode and the negative electrode. Then, this laminated body was put in a bag-shaped separator, which was then put inside a laminate outer case. Then, a non-aqueous electrolyte solution was injected into the inside of the outer covering, an opening of the laminate outer covering was then sealed by heat fusion, and a lithium ion secondary battery for an evaluation test (Test Example 1) was constructed by activation. It should be noted that in this test, a non-aqueous electrolyte solution containing LiPF₆ as a supporting salt at a concentration of about 1.16 mol/L in a mixed solvent having EC, EMC and DMC in a volume ratio of 3:3:4 was used.

### (2) Test Examples 2 and 3

In Test Examples 2 and 3, lithium ion secondary batteries for the evaluation test were constructed in the same conditions as in Test Example 1 except that the Li collector (thymol blue herein) was added. It should be noted that the specific concentrations of the Li collector in the non-aqueous electrolyte solution are as shown in Table 1.

### 2. Evaluation Test

Subsequently, in this Test Example, the amount of deposited metallic Li was measured by a charge-discharge test of the lithium ion secondary batteries in Test Examples 1 to 3. Specifically, the lithium ion secondary batteries in Test Examples were subjected to 100 cycles of charge and discharge, in which CC charge at a 5C constant current from 3 V to 4.2 V under an environment of −10° C. was followed by a pause for 2 minutes, CC discharge at a 5C constant current (CC discharge) from 4.2 V to 3 V, and a pause for 2 minutes. Then, the batteries after the charge and discharge cycles were dismantled and checked visually, and the area (mm²) of the region of deposited metallic Li(Li deposited region) was measured on the surface of the negative electrode active material layer. The measurement results are shown in Table 1.

TABLE 1

| | Concentration of Li collector | Area of Li |
|---|---|---|
| Test | in non-aqueous electrolyte | deposited |
| Example | solution (mmol/L) | region (mm²) |
| 1 | 0 | 500 |
| 2 | 0.2 | 380 |
| 3 | 1.1 | 130 |

As shown in Table 1, it was verified that the areas of the Li deposited regions in Test Examples 2 and 3 were smaller than in Test Example 1. This found that deposition of metallic Li could be suppressed by adding a Li collector to a non-aqueous electrolyte solution. It was also found that the concentration of a Li collector in a non-aqueous electrolyte solution was preferably at least 0.2 mmol/L.

As described above, specific aspects of the techniques disclosed herein include those described in the following items.

### Item 1:

A non-aqueous electrolyte solution for a lithium ion secondary battery, including
a supporting salt,
a non-aqueous solvent, and
a compound having a triphenylmethane skeleton,
wherein the compound includes
   a branched hydrocarbon group existing on a phenyl group in the triphenylmethane skeleton and having 3 or more carbon atoms, and
   a hydroxy group existing on the phenyl group and being next to the branched hydrocarbon group.

### Item 2:

The non-aqueous electrolyte solution according to Item 1, wherein the branched hydrocarbon group includes at least one selected from the group consisting of an isopropyl group, an isobutyl group, a sec-butyl group and a tert-butyl group.

### Item 3:

The non-aqueous electrolyte solution according to Item 1 or 2, wherein the compound is at least one selected from the group consisting of thymol blue, bromothymol blue and methylthymol blue.

### Item 4:

The non-aqueous electrolyte solution according to any one of Items 1 to 3, wherein the non-aqueous solvent includes a non-aqueous solvent belonging to carbonates.

### Item 5:

The non-aqueous electrolyte solution according to any one of Items 1 to 4, wherein the concentration of the compound is at least 0.2 mmol/L.

### Item 6:

A lithium ion secondary battery, including
a positive electrode.
a negative electrode, and
the non-aqueous electrolyte solution according to any one of Items 1 to 5.

What is claimed is:

1. A non-aqueous electrolyte solution for a lithium ion secondary battery, comprising:
a supporting salt;
a non-aqueous solvent; and
a compound having a triphenylmethane skeleton,
wherein the compound comprises
a branched hydrocarbon group existing on a phenyl group in the triphenylmethane skeleton and having 3 or more carbon atoms, and
a hydroxy group existing on the phenyl group and being next to the branched hydrocarbon group.

2. The non-aqueous electrolyte solution according to claim 1, wherein the branched hydrocarbon group comprises at least one selected from a group consisting of an isopropyl group, an isobutyl group, a sec-butyl group and a tert-butyl group.

3. The non-aqueous electrolyte solution according to claim 1, wherein the compound is at least one selected from a group consisting of thymol blue, bromothymol blue and methylthymol blue.

4. The non-aqueous electrolyte solution according to claim 1, wherein the non-aqueous solvent comprises a non-aqueous solvent belonging to carbonates.

5. The non-aqueous electrolyte solution according to claim 1, wherein a concentration of the compound is at least 0.2 mmol/L.

6. A lithium ion secondary battery, comprising:
a positive electrode;
a negative electrode; and
the non-aqueous electrolyte solution according to claim 1.
